(19) United States
(12) Patent Application Publication
(10) Pub. No.: US 2008/0144204 A1
(43) Pub. Date: Jun. 19, 2008

(54) Fixed exterior automotive mirror with two-piece bracket

(75) Inventors: Don Iacovoni, Plymouth, MI (US); Paul Heirtzler, Northville, MI (US)

Correspondence Address: MILLER LAW GROUP, PLLC;AND FORD GLOBAL TECHNOLOGIES, INC., 25 STEVENS AVENUE, WEST LAWN, PA, 19609, US

(73) Assignee: Ford Global Technologies, LLC

(21) Appl. No.: 11/642,463

(22) Filed: Dec. 19, 2006

(51) Int. Cl. G02B 7/182

(52) U.S. Cl. 359/879; 359/871

(57) ABSTRACT

A two piece mirror support bracket is formed with a sail side half and a mirror side half joined together at an interface to permit the mirror support bracket to pass through a mirror pedestal without requiring the enlarged head on either half to pass through the mirror pedestal. The two halves of the mirror support bracket are joined by mechanical fasteners to form an integral apparatus operable to support the mirror glass and actuator assembly from the automotive chassis at the mirror sail. The mechanical fasteners can include heat stakes to fix the mirror side half and the sail side half together. The smaller mirror pedestal reduces wind noise and aerodynamic drag, while increasing the flexibility for design styling of the automobile, without requiring a design change for the mirror glass or actuator mechanism for manipulating the orientation of the mirror glass.

### FIELD OF THE INVENTION

This invention relates generally to a fixed automotive exterior mirror and, more particularly, to a support bracket for the mirror capable of fitting through a narrow pedestal.

### BACKGROUND OF THE INVENTION

Many automobiles are provided with fixed exterior mirrors. A fixed exterior mirror is one that has an outer housing that does not contain a pivot mechanism that allows the position or orientation of the mirror glass to be moved at the convenience of the operator. Fixed exterior mirrors have a fixed housing with the mirror glass attached to an actuator mechanism supported on a bracket to allow a positioning of the mirror glass at the convenience of the operator. This positioning of the mirror glass is typically done by remotely located controls that operate the actuator for orienting the mirror glass.

The mirror housing is formed of a housing member in which the mirror glass is located, a mirror sail that is affixed to the body of the automobile, and a mirror pedestal that interconnects the housing member and the mirror sail so as to position the housing member at a location outboard from the automobile body. The support bracket for the mirror glass has a sail side portion that is positioned within the mirror sail for mounting on the automobile body and a glass side portion that is positioned within the housing member to support the actuator and the mirror glass. Both the glass side portion and the sail side portion are larger in dimension than a bridge portion of the support bracket interconnecting the glass side portion and the sail side portion. The bridge portion of the support bracket passes through the mirror pedestal.

The size of the mirror pedestal often needs to be larger than is desired for the styling of the exterior mirror because the both the glass side portion and the sail side portion are larger than the bridge portion interconnecting them and the mirror pedestal has to be large enough to pass either the glass side portion or the sail side portion through the mirror pedestal. This larger than desired mirror pedestal increases wind noise and aerodynamic drag, and reduces the flexibility in styling design.

The oversized mirror pedestal for accommodating the passage of the enlarged mirror support head can be seen in U.S. Pat. No. 4,998,814, granted to William Perry on Mar. 12, 1991, where the mirror pedestal has a height that is substantially larger than the height of the mirror support bracket extending through the mirror pedestal. In U.S. Design Pat. No. D516,479, issued on Mar. 7, 2006, and in U.S. Design Pat. No. D519,428, issued on Apr. 25, 2006, both of which were granted to Tony Ervolina, a detachable mirror sail member is disclosed in which the mirror pedestal to which the mirror sail member is attached is substantially smaller than the height of the mirror sail member. Neither of the Ervolina design patents, however, contains any teaching relating to the assembly of a mirror support bracket into a fixed mirror housing so as to provide a smaller mirror pedestal.

U.S. Pat. No. 6,116,743, granted on Sep. 12, 2000, to Steven Hock discloses a mirror assembly having a mirror support member that is formed of only the mirror glass support head mounted in the mirror shell housing. A support arm pivotally connects the mirror sail and the mirror shell housing to permit the mirror shell housing to be pivotally moved relative to the car chassis; however, the mirror support bracket does not extend through the support arm pedestal. The mirror assembly in U.S. Pat. No. 6,310,738, issued on Oct. 30, 2001, to Tun-Jen Chu is similar to the Hock patent in that the mirror glass is supported on a support head that is mounted in the mirror shell housing, which is connected to the mirror sail member. The mirror support bracket does not extend through the pedestal in the manner of a fixed mirror housing.

It would be desirable to provide a mirror support bracket that can be used in a fixed exterior automotive mirror to provide a thin mirror pedestal having the bridge portion of the mirror support bracket passing through the mirror pedestal.

### SUMMARY OF THE INVENTION

It is an object of this invention to overcome the aforementioned disadvantages of the known prior art by providing a two piece mirror support bracket for use with a fixed exterior automotive mirror assembly.

It is another object of this invention to provide a fixed exterior mirror assembly in which the mirror pedestal has a height that is less than the height of the support heads at either end of the support bracket.

It is a feature of this invention to provide a mirror support bracket that is assembled after being passed through the mirror pedestal.

It is an advantage of this invention that the mirror pedestal can be formed with a smaller height dimension.

It is another advantage of this invention that the smaller height dimension for the mirror pedestal reduces wind noise created by air moving between the mirror shell housing and the mirror sail over the mirror pedestal.

It is still another advantage of this invention that the smaller height dimension for the mirror pedestal reduces aerodynamic drag associated with the mirror assembly.

It is yet another advantage of this invention that the smaller height dimension for the mirror pedestal allows greater flexibility in styling for the automobile.

It is another feature of this invention that the two pieces of the mirror support bracket can be secured by mechanical fasteners.

It is still another feature of this invention that the two pieces of the mirror support bracket can be secured together by heat stakes to form an integral mirror support bracket after being positioned within the mirror pedestal.

It is still another advantage of this invention that the large support head at opposing ends of the mirror support bracket do not have to be fed through the mirror pedestal to affect assembly thereof.

It is yet another advantage of this invention that the required height of the mirror pedestal can be reduced in half.

It is yet another feature of this invention that changes to the mounting and actuation of the mirror glass in an exterior automotive mirror assembly do not require revision to affect a reduction in the height of the mirror pedestal.

It is a further feature of this invention that the interface between the two halves of the mirror support bracket can be notched to enhance the engagement therebetween at the interface surface.

It is a further advantage of this invention that the styling design of automobiles is not restricted by a large mirror pedestal.

It is still a further feature of this invention that the interface area between the two halves of the mirror support bracket can be reinforced by a reinforcement clip applied to the exterior of the mirror support bracket.

It is a further object of this invention to provide a two piece support bracket for a fixed exterior automotive mirror that is durable in construction, inexpensive of manufacture, carefree of maintenance, facile in assemblage, and simple and effective in use.

These and other objects, features and advantages are accomplished according to the instant invention by providing a two piece mirror support bracket formed with a sail side half and a mirror side half joined together at an interface to permit the mirror support bracket to pass through a mirror pedestal without requiring the enlarged head on either half to pass through the mirror pedestal. The two halves of the mirror support bracket are joined by mechanical fasteners to form an integral apparatus operable to support the mirror glass and actuator assembly from the automotive body at the mirror sail. The mechanical fasteners can include heat stakes to fix the mirror side half and the sail side half together. The smaller mirror pedestal reduces wind noise and aerodynamic drag, while increasing the flexibility for design styling of the automobile, without requiring a design change for the mirror glass or actuator mechanism for manipulating the orientation of the mirror glass.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a front perspective view of an automotive mirror assembly incorporating the principles of the instant invention;

FIG. 2 is a rear mirror side perspective view of the mirror assembly shown in FIG. 1, the mirror glass and actuator mechanism being removed for the purpose of clarity;

FIG. 3 is a rear sail side perspective view of the mirror assembly shown in FIG. 1;

FIG. 4 is a front mirror side perspective view of the mirror assembly shown in FIG. 4, the mirror housing being removed to better view the mirror support bracket incorporating the principles of the instant invention;

FIG. 5 is an enlarged rear elevational view of the interface area between the sail side half and the mirror side half of the mirror support bracket depicted in FIG. 2;

FIG. 6 is an exploded schematic partial elevational view of the interface area of the mirror support bracket to shown the notched areas;

FIG. 7 is a schematic cross-sectional view of the interface area taken orthogonally to the view of FIG. 6;

FIG. 8A is a diagrammatic view of a first embodiment of the heat stake mechanical fastener prior to being activated;

FIG. 8B is a diagrammatic view of the first embodiment of the heat stake mechanical fastener after to being activated;

FIG. 9A is a diagrammatic view of a second embodiment of the heat stake mechanical fastener prior to being activated;

FIG. 9B is a diagrammatic view of the second embodiment of the heat stake mechanical fastener after to being activated;

FIG. 10 is an exploded diagrammatic top plan view of the interface area utilizing heat stake mechanical fasteners;

FIG. 11 is a diagrammatic elevational view of the interface area taken orthogonally to the view depicted in FIG. 10;

FIG. 12A is a diagrammatic view of a third embodiment of the heat stake mechanical fastener prior to being activated;

FIG. 12B is a diagrammatic view of the third embodiment of the heat stake mechanical fastener after to being activated;

FIG. 13A is a diagrammatic view of a fourth embodiment of the heat stake mechanical fastener prior to being activated; and

FIG. 13B is a diagrammatic view of the fourth embodiment of the heat stake mechanical fastener after to being activated.

### DETAILED DESCRIPTION OF THE PREFERRED EMBODIMENT

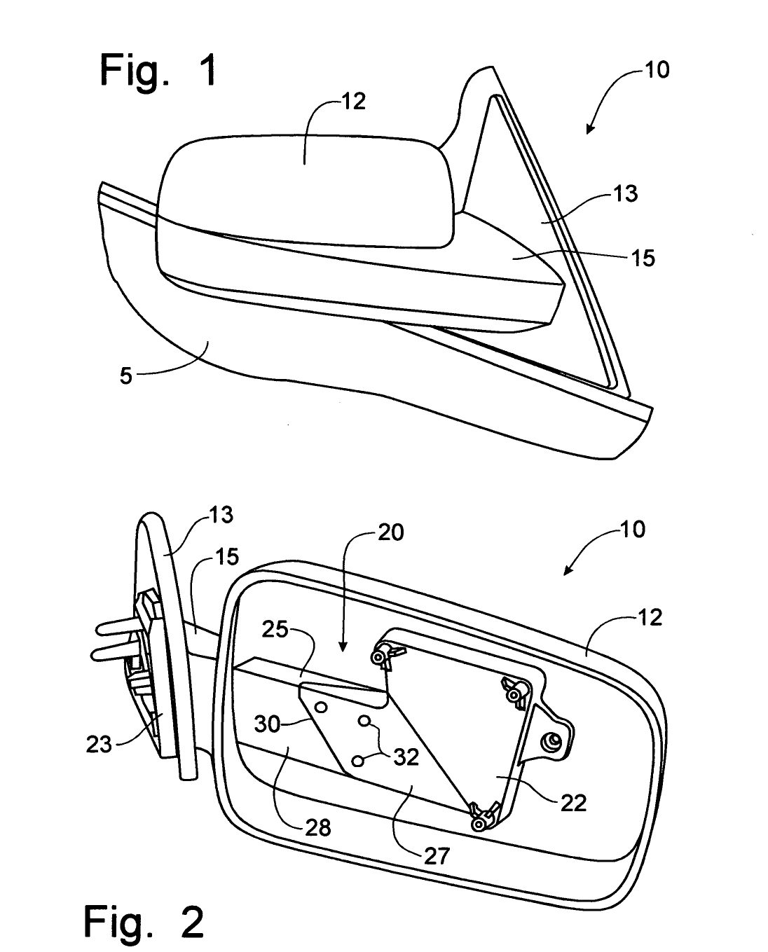

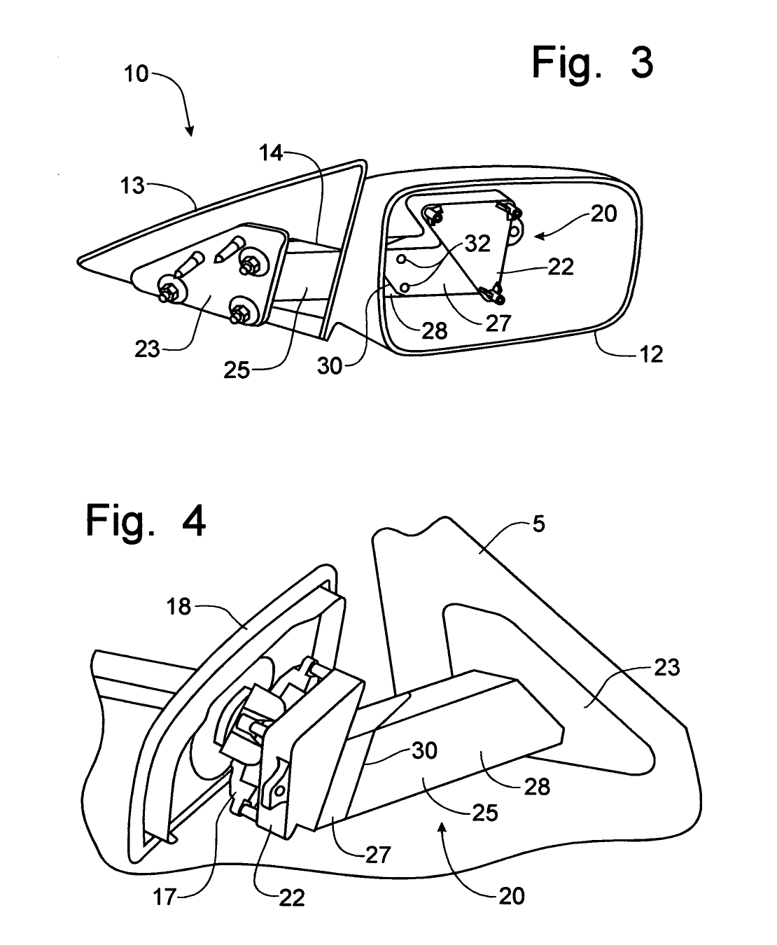

Referring to FIGS. 1-4, a fixed exterior automotive mirror for use on an automotive vehicle incorporating the principles of the instant invention can best be seen. The vehicle 5 can be any style or model, but is typically a passenger car instead of a sport utility vehicle or a pick-up truck, and deploys a fixed exterior mirror assembly 10 on both opposing laterally spaced sides of the vehicle 5, although the drawings only depict the mirror assembly 10 mounted on the passenger side of the vehicle 5.

The mirror assembly 10 is formed with a mirror shell housing portion 12, a mirror sail portion 14 and a mirror pedestal 15 interconnecting the shell housing 12 and the mirror sail 13. The mirror sail portion 13 is mounted on the chassis of the vehicle 5 to support the mirror assembly 10 therefrom. The mirror pedestal 15 and the attached mirror shell housing 12 project laterally outwardly from the mirror sail portion 13.

The mirror support bracket 20 has a mirror glass mounting head 22 and a sail side attachment head 23 and a bridge portion 25 that extends between the mirror glass mounting head 22 and the sail side attachment head 23. The bridge portion 25 passes through the hollow pedestal 15 to support the mirror glass mounting head 22 from the attachment head 23. The attachment head 23 is affixed mechanically to the automobile chassis 5 and covered by the mirror sail portion 13 for aesthetic purposes. The mirror glass mounting head 22 and the attachment head 23 are both significantly larger in dimension than the bridge portion 25 that interconnects them. In known mirror support brackets, the pedestal 15 is formed sufficiently large in terms of vertical height and longitudinal depth to permit the passage of the mirror glass mounting head 22 through the pedestal 15 to affect assembly of the mirror assembly 10.

To accomplish the desire to reduce the size of the mirror pedestal 15 without requiring a change in design of the attachment head 23 or the mirror glass mounting head 22, the bridge portion 25 is divided into two halves, a mirror side half 27 and a sail side half 28, joined together at an interface 30. After the mirror assembly 10 is assembled, as described in greater detail below, the two halves 27, 28 are joined together at the interface 30 by mechanical fasteners 32 to create an integral mirror support bracket 20.

Assembly of the mirror assembly 10 is accomplished by passing the bridge portion 25 of the sail side half 28 through the opening 14 leading to the mirror pedestal 15, then attaching the mirror side portion 28 at the interface using the mechanical fasteners, such as described below. The mirror support bracket 20 is then completed and is ready for the attachment of the sail side attachment head 23 to the vehicle chassis 5 and for the mounting of the actuator subassembly 17 to the mirror glass mounting head 22 and then the mirror glass 18 to the actuator subassembly 17 to complete the assembly of the mirror assembly 10. The mirror sail 13 is typically affixed to the vehicle 5 in a known manner to aesthetically cover the attachment head 23.

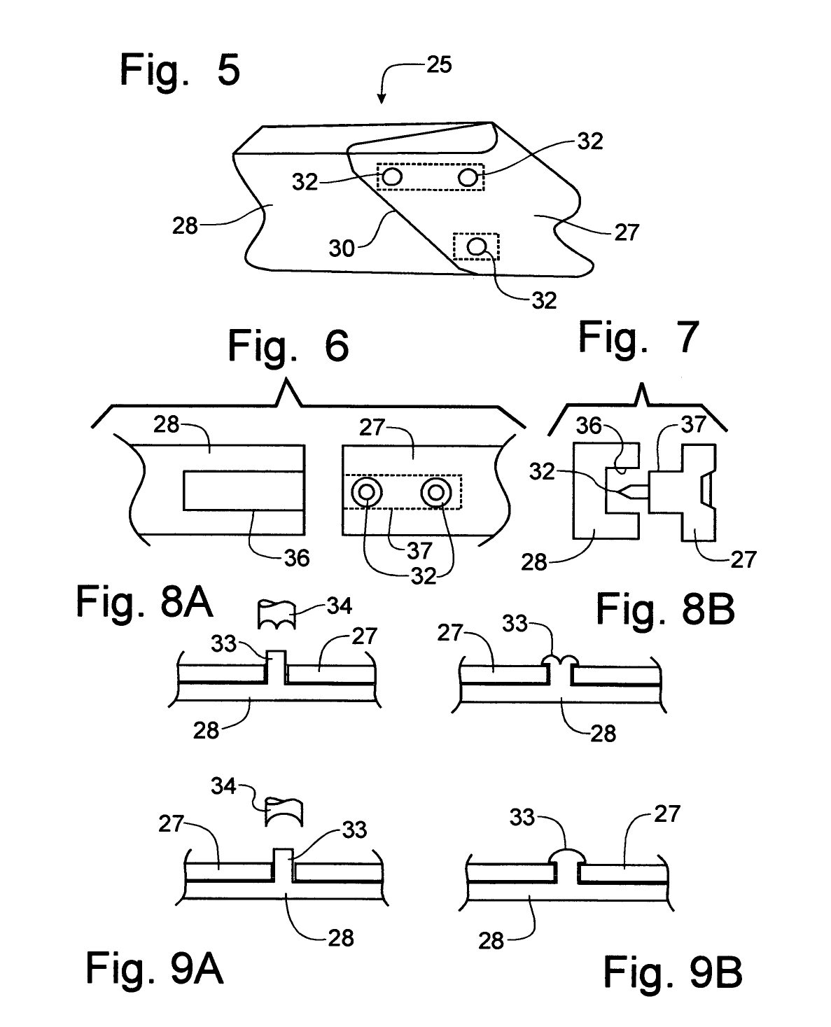

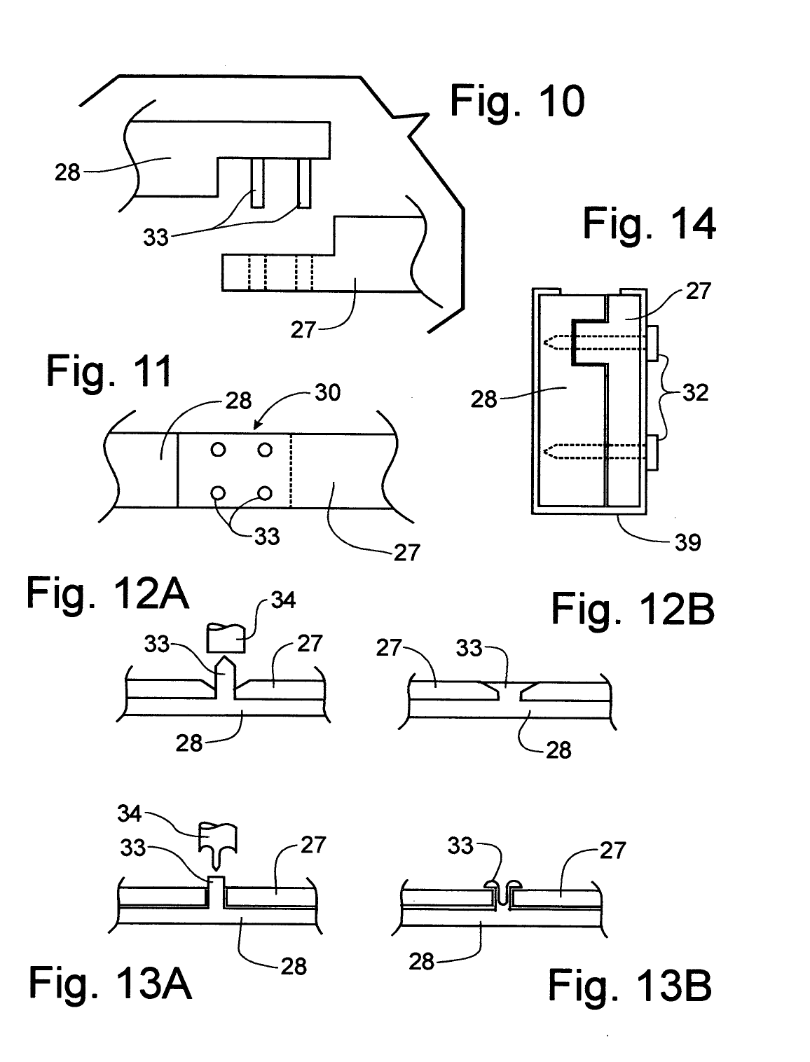

Examples of the interface 30 and the mechanical fasteners 32 can be seen in FIGS. 5-13B. The interface 30 can be smooth and supported only by the mechanical fasteners 30. To increase the strength of the interface joint 30, however, the interface 30 is preferably formed with some form of longitudinal convolution, such as the notches 35 shown in FIGS. 5-7. The notches 35, formed as a recession 36 on one of the halves 27, 28 with a mating projection 37 formed on the other half 27, 28, resist both vertical movement of one half 27, relative to the other half 28, and also transverse movement thereof. Longitudinal movement of one half 27 relative to the other half 28 is resisted by the operation of the mechanical fastener 32, which can be a screw, as represented in FIG. 7, or a heat stake as is represented in FIGS. 8A-9B, and FIGS. 12A-13B.

The heat stakes 33 are known in the fastener art and, as seen in FIGS. 8A-13B, the heat stake is a deformable plastic member that is formed on one half 28 of the mirror support bracket 20 and project through a suitable opening in the other half 27 such that the heat stake 33 projects through the other half 27. A melting fixture 34, which can be in a number of different configurations, depending on the shape of the heat stake rivet that is desired. For example, as shown in FIG. 8A, the melting fixture 34 could be formed in a double arch configuration to form a heat stake rivet that has a split appearance, as is seen in FIG. 8B. Another example is depicted in FIG. 9A in which a single arched melting fixture 34 configuration is utilized to produced a domed rivet head 33 as is depicted in FIG. 9B. Other examples of the melting fixture 34 include the flat configuration depicted in FIG. 12A, which produces a flush mount head that is best used with a countersunk opening through the mating half 27, or the spiked configuration depicted in FIG. 13A that produces a hollowed rivet head 33 as depicted in FIG. 13B.

The use of a two piece mirror support bracket 20 that can be assembled through the mirror pedestal without requiring the enlarged attachment head 23 or the enlarged mirror glass mounting head 22 to pass through the hollow pedestal 15 allows the mirror pedestal 15 to be formed with a minimum vertical height, approximately half of the height previously known in the art. The vertical height limitations for the mirror pedestal 15 is only the height required to allow the passage of the bridge portion 25 of the sail side half 28 of the mirror support bracket 20. The minimal height mirror pedestal 15 will reduce the wind noise created while the vehicle 5 is moving and air is forced around the mirror assembly 10, and particularly between the mirror sail 13 and the shell housing 12 over the mirror pedestal 15. The reduced height mirror pedestal 15 will also reduce aerodynamic drag as a direct result of the smaller profile present to the air while the vehicle 5 is moving. Lastly, the lower height mirror pedestal 15 allows a more flexibly styling approach to be used as the large mirror pedestal is not a styling limitation or restriction.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A fixed exterior automotive mirror assembly, comprising:
a mirror housing having a sail portion, a shell portion spaced laterally away from said sail portion, and a pedestal interconnecting said shell portion and said sail portion;
a mirror support bracket including a glass mounting head, a sail side attachment head and a bridge portion interconnecting said glass mounting head and said sail side attachment head, said mirror support bracket being divided into two pieces, a first piece having said sail side attachment head at one end thereof and a second piece having said glass mounting head at one end thereof, said first piece and said second piece having mating engagement faces forming an interface where fasteners interconnect said first and second pieces to form said mirror support bracket.

2. The mirror assembly of claim 1 wherein the interface is located along said bridge portion.

3. The mirror assembly of claim 2 wherein the interface is located closer to said mounting head than said attachment head.

4. The mirror assembly of claim 3 wherein said fasteners are screws.

5. The mirror assembly of claim 3 wherein said interface is formed with a convoluted surface to enhance the strength of the interface.

6. The mirror assembly of claim 3 wherein the convoluted surface includes a notch formed as a recess at one piece and a mating projection in the other piece.

7. The mirror assembly of claim 6 wherein at least one of said fasteners passes through said notch.

8. The mirror assembly of claim 7 wherein said fasteners are heat stakes that connect said first and second pieces into an integral mirror support bracket.

9. The mirror assembly of claim 7 wherein said attachment head and said glass mounting head are dimensionally larger than said pedestal.

10. In an automotive vehicle having a fixed exterior mirror including a mirror housing having a sail portion, a shell portion and a pedestal interconnecting said sail portion and said shell portion; and a mirror support bracket having an attachment head beneath said sail portion, a glass mounting head within said shell portion, and a bridge portion interconnecting said attachment head and said glass mounting head, said bridge portion being positioned within said pedestal, the improvement comprising:
said pedestal having dimensions smaller than said attachment head and said glass mounting head, said mirror support bracket being divided into two pieces, a first piece having said attachment head at one end thereof and a second piece having said glass mounting head at an opposing end thereof, said first piece and said second piece having mating engagement faces forming an interface where fasteners interconnect said first and second pieces to form said mirror support bracket.

11. The automotive vehicle of claim 10 wherein the interface is located along said bridge portion.

12. The automotive vehicle of claim 11 wherein said interface is formed with a convoluted surface to enhance the strength of the interface.

13. The automotive vehicle of claim 12 wherein the convoluted surface includes a notch formed as a recess at one piece and a mating projection in the other piece.

14. The automotive vehicle of claim 13 wherein at least one of said fasteners passes through said notch.

15. The automotive vehicle of claim 14 wherein the interface is located closer to said mounting head than said attachment head.

16. The automotive vehicle of claim 15 wherein said fasteners are heat stakes that connect said first and second pieces into an integral mirror support bracket.

17. The mirror assembly of claim 15 wherein said fasteners are screws.

18. A method of assembling a fixed exterior mirror on an automobile having a chassis, said fixed exterior mirror including a mirror housing having a sail portion connectable to said chassis, a shell portion spaced remotely of said sail portion, and a pedestal interconnecting said sail portion and said shell portion to support said shell portion outboard of said chassis, comprising the steps of:
passing a first bridge portion of a first piece of a mirror support bracket through said pedestal, said first piece having an attachment head formed at one end of said first bridge portion, said attachment head being dimensionally larger than said pedestal;
attaching a second bridge portion of a second piece of said mirror support bracket by fasteners to said first bridge portion along an interface located within said shell portion of said mirror housing, said second piece having a glass mounting head that is dimensionally larger than said pedestal;
mounting an actuator subassembly to said glass mounting head;
supporting a mirror glass on said actuator subassembly; and
connecting said attachment head to said chassis.

19. The method of claim 18 wherein said attaching step includes the step of engaging a first convoluted engagement face on said first bridge portion with a mating convoluted engagement face on said second bridge portion to form said interface.

20. The method of claim 19 wherein the attaching step further includes the step of using heat stakes as said fasteners to integrally attach said second piece of said mirror bracket to said first piece to form said mirror support bracket.
